(19) United States
(12) Patent Application Publication
(10) Pub. No.: US 2013/0082528 A1
(43) Pub. Date: Apr. 4, 2013

(54) ACTIVE ISOLATED POWER SUPPLY WITH MULTIPLE OUTPUTS

(71) Applicants: Bin Wang, Shanghai (CN); Xibing Ding, Shanghai (CN); Yaping Yang, Shanghai (CN); Hongyang Wu, Shanghai (CN)

(72) Inventors: Bin Wang, Shanghai (CN); Xibing Ding, Shanghai (CN); Yaping Yang, Shanghai (CN); Hongyang Wu, Shanghai (CN)

(73) Assignee: DELTA ELECTRONICS (SHANGHAI) CO., LTD, Shanghai (CN)

(21) Appl. No.: 13/444,345

(22) Filed: Apr. 11, 2012

(30) Foreign Application Priority Data
Sep. 30, 2011 (CN) 201110295896.7

(51) Int. Cl. H02J 3/00

(52) U.S. Cl. 307/35

(57) ABSTRACT

An active isolated power supply with multiple outputs is provided. The power supply includes N transformers T1˜Tn connected to output terminals of AC source, the primary circuits of transformers T1˜Tn are connected in parallel with each other, wherein N is a positive integral number equals to or greater than 2, and N switching devices S1˜Sn or N−1 switching devices S1˜Sn−1 connected in series with the primary circuits of transformers T1˜Tn respectively, to restrict the current direction of the primary circuits of transformers T1˜Tn. Herein, N output power supplies isolated with each other are generated on the secondary sides of transformers T1˜Tn. Therefore, flow direction of current in the primary sides of the transformers is fixed by present invention, such that each transformer can accomplish magnetic reset in one operation period, thereby avoiding the occurrence of current circulation between the primary circuits.

### CROSS REFERENCE TO RELATED APPLICATIONS

The present invention claims priority under 35 U.S.C. §119 to Chinese Patent Application No. 201110295896.7, filed on Sep. 30, 2011, the entire content of which is incorporated herein by reference.

### FIELD OF THE INVENTION

The present invention generally relates to DC power supply with multiple outputs used in power electronic technology, and more particularly to an active isolated power supply with multiple outputs suitable for high voltage and high power situation.

### BACKGROUND OF THE INVENTION

The fast development of power electronic technology makes the application of the active isolated power supply with multiple outputs become more and more widely. For example, Active Power Filter (called APF for short), which can compensate for changing reactive power and harmonics having constantly changing amplitude and frequency, is a new power electronic equipment used to dynamically suppress harmonics and compensate for reactive power. This equipment is called “active” because it needs to be fed with multiple output isolated powers with high voltage and high power, just as its name implies.

FIG. 1 shows a diagram of an isolated power supply with multiple outputs of the prior art. As shown in FIG. 1, in the primary side of the isolated power supply with multiple outputs, usually full-bridge circuit, half-bridge circuit, forward converter, flyback converter or other circuit feeds AC power to the primary input terminal AB of each transformers T1˜Tn, which is directly connected in parallel to input terminal of AC power source. And on the secondary side of the isolated power supply with multiple outputs, AC power output from the isolated output terminal of each transformers T1˜Tn is converted to DC power by rectifying devices, so as to feed power to multiple load connected therein.

However, all the primary sides of the isolated transformers T1˜Tn are directly connected in parallel with each other, and the load levels of the secondary sides of each transformers T1˜Tn may be different, thus such connection can cause current circulation among the primary circuits of isolated transformers T1˜Tn. This current circulation will induce magnetic bias of the isolated transformers T1˜Tn, and isolated transformers T1˜Tn will become saturated if the amount of magnetic bias beyond a threshold value. Consequently, in order to prevent the isolated transformers T1˜Tn from being saturated, i.e. to assure that the magnetic bias will not cause the saturation of the isolated transformers T1˜Tn in any circumstances, the margin design of the isolated transformers T1˜Tn needs to be increased.

Next, how the magnetic bias happens will be described in detail by referring FIG. 2 and FIG. 3. It is noted that for the sake of simplicity of statement, there are only two transformers in the figures, that is the first transformer T1 and the second transformer T2.

FIG. 2 is the equivalent circuit diagram of the active isolated power supply with multiple outputs in the prior art, where the primary sides of the two transformers T1 and T2 are directly connected in parallel with each other. Lm1 and Lm2 are respectively equivalent magnetic inductances of transformers T1 and T2 connected in parallel, Vo1 and Vo2 are DC rectifying voltage from the two output terminals of the secondary sides of transformers T1 and T2. Switching devices (i.e. diodes D1 and D2) are respectively connected in series with the secondary sides of the transformers T1 and T2, and capacitors C1 and C2 are respectively connected in parallel between the two output terminals of the active isolated power supply with multiple outputs.

FIG. 3 is a diagram showing the analysis of the current circulation in the case that the circuit shown in FIG. 2 has two different loads. As shown in the figure, V_{AB} represents the AC voltage waveform across the input terminal AB. During the time period of t0˜t1, the voltage value of V_{AB} is positive, and the current waveforms of primary sides of the transformers T1 and T2 are shown as iT in theory, which are positive triangular wave. The current waveforms of the primary sides of transformers T1 and T2 comprise a magnetizing current iLm (iLm1 or iLm2) due to the existence of magnetic inductance, the difference of current iT and current iLm1 is current induced to the secondary side of the first transformer T1, and the difference of current iT and current iLm2 is current induced to the secondary side of the second transformer T2. At moment t1, the voltage value of V_{AB} suddenly changes from positive to negative, causing the current induced to the secondary side of the first and second transformer abruptly cut off. However, the magnetic current iLm (iLm1 or iLm2) is unable to change suddenly, the magnetic current iLm (iLm1 or iLm2) decreases slowly until to be zero in the time period of t1˜t2, and meanwhile the voltage value of V_{AB} returns to zero. Under this circumstance, only if the area of positive section of voltage V_{AB} equals to that of negative section of voltage V_{AB}, i.e. satisfying Voltage-Second Balance Principle in the electromagnetism, the magnetic current iLm (iLm1 or iLm2) of the primary side of transformer T1 or T2 will return to zero, their magnetic core will accomplish magnetic reset and won't lead to saturation.

However, as can be seen from the figures, the primary sides of transformers T1 and T2 are directly connected in parallel with each other, the value of Vo1 and Vo2 may be slightly different due to the difference of the output loads on the secondary sides of transformers T1 and T2, which can cause different rising slopes of the magnetic current of the transformers, as iLm1 and iLm2 shown in FIG. 3. On the other hand, after the voltage value of V_{AB} becomes negative, i.e. in time period t1˜t2, the two current iLm1 and iLm2 decrease with respective declining rate until the sum of them equals to zero (i.e. during the time period of t2˜t3 in the figure), and meanwhile the voltage value of V_{AB} returns to zero. Nevertheless, during the time period of t2˜t3, whether the current iLm1 or current iLm2, none of them become zero, and the current iLm2 has become negative, thus, resulting in the current circulation between the primary circuits of the two transformers T1 and T2. Worse still, during the following period and afterwards, the current iLm1 and iLm2 will become more and more divergent till losing control of them. The growing currents during several periods cause magnetic flux of magnetic core to increase until saturation of magnetic core. In order to avoid the phenomenon, conventional handling method is utilizing large-sized transformers T1 and T2 to achieve large magnetic core saturation margin, so that the magnetic core won't saturate even if in the case of big magnetic current and magnetic bias.

Therefore, how to avoid the transformer saturation induced by the current circulation of the primary sides of the power isolated transformers, as well as making transformer and the whole power supply smaller and lighter are indeed pressing problems currently to be resolved.

### SUMMARY OF THE INVENTION

In view of that the current circulation among the primary sides of the isolated power supply with multiple outputs can induce saturation of magnetic cores, leading to increased bulk and weight of the transformers, the present invention seeks to eliminate the current circulation between the transformers due to difference of loads by making the direction of current on the primary sides of transformers fixed. Thus, each transformer could achieve magnetic reset in one operation period. Consequently, margin will not need to be considered in the design of transformers so that it is possible to make smaller transformers.

In order to achieve the objective mentioned above, technical resolution of the present invention is stated as follows:

An active isolated power supply with multiple outputs comprises N transformers T1˜Tn connected to output terminals of AC source, the primary circuits of transformers T1˜Tn are connected in parallel with each other, wherein N is a positive integral number equals to or greater than 2, and N switching devices S1˜Sn or N−1 switching devices S1˜Sn−1 connected in series with the primary circuits of transformers T1˜Tn respectively, to restrict the current direction of the primary circuits of transformers T1˜Tn. Herein, N output power supplies isolated with each other are generated on the secondary sides of transformers T1˜Tn.

According to the present invention, the secondary sides of transformers T1˜Tn also comprises rectifying circuits, which rectify the N AC output power supplies to obtain N DC power supplies isolated with each other.

According to the present invention, AC voltage from the AC Source is generated via a push-pull circuit, a forward circuit, a flyback circuit or a series isolated chopping circuit.

According to the present invention, the rectifying circuits of transformers T1˜Tn are a half-wave rectifying circuit, a full-wave rectifying circuit, or a synchronous rectifying circuit.

According to the present invention, the switching devices S1˜Sn or S1˜Sn−1 on the primary sides of transformers T1˜Tn are diodes.

According to the present invention, the switching devices S1˜Sn or S1˜Sn−1 on the primary sides of transformers T1˜Tn are MOSFETs, which are controlled by controlling unit to be on or off.

According to the present invention, the switching devices S1˜Sn or S1˜Sn−1 on the primary sides of transformers T1˜Tn are IGBTs, which are controlled by controlling unit to be on or off.

According to the present invention, the switching devices S1˜Sn or S1˜Sn−1 on the primary sides of transformers T1˜Tn are relays.

In order to achieve the objective mentioned above, another technical resolution of the present invention is stated as follows:

An active power filter comprises main power circuit, the main power circuit comprises M switching devices K1˜Km and matched driving circuits thereof, wherein M is a positive integral number equals to or greater than 2, and also the main power further comprises the active isolated power supply with multiple outputs as stated above, the input terminals of the active isolated power supply with multiple outputs receive AC power from AC source to feed power to the driving circuits.

According to the present invention, the switching devices K1˜Km are IGBTs or MOSFETs.

According to the present invention, switching devices connected in series with the primary sides of transformers of the active isolated power supply with multiple outputs are diodes, rectifying circuits on the secondary sides of the transformers are an half-cycle uncontrolled rectifying circuits.

As can be seen from the technical resolution stated above, the primary circuits of the isolated transformers of the active isolated power supply with multiple outputs provided are not directly connected in parallel with each other, but N switching devices S1˜Sn or N−1 switching devices S1˜Sn−1 are connected in series with the primary circuits of transformers T1˜Tn. Herein, N output power supplies isolated with each other are generated on the secondary sides of transformers T1˜Tn. Thus, current direction of any primary side of transformers T1˜Tn is fixed, and the current circulation will not occur. That is to say, each transformer can accomplish magnetic reset in one operation period. In the designing of transformers of the active isolated power supply with multiple outputs, design margin that prevents the occurrence of saturation of magnetic cores induced by uptrend of magnetic current will not need to be considered, the bulk of each magnetic core is small. It is turned out that the bulk of transformer used in the present invention is less than that of transformer used in the prior art by 70%. In case that output power, performance of power supply and number of outputs are the same, compared to other active isolated power supply with multiple outputs, the active isolated power supply with multiple outputs of the present invention has obvious advantages, such as small-size, light weight, high efficiency and reliability, etc.

### BRIEF DESCRIPTION OF THE DRAWINGS

FIG. 1 shows a diagram of an isolated power supply with multiple outputs of the prior art

FIG. 2 is the equivalent circuit diagram of the active isolated power supply with multiple outputs in the prior art, where the primary sides of the two transformers T1 and T2 are directly connected in parallel with each other

FIG. 3 is a diagram showing the analysis of the current circulation in the case that the circuit shown in FIG. 2 has two different loads

FIG. 4.1 shows a circuit schematic diagram of an active isolated power supply with multiple outputs according to a preferred embodiment of the present invention

FIG. 4.2 shows a circuit schematic diagram of an active isolated power supply with multiple outputs according to another preferred embodiment of the present invention

FIG. 5 shows a schematic diagram of the current circulation of active isolated power supply with multiple outputs under the circumstance of having two different loads according to the embodiment of present invention

FIG. 6 shows a circuit schematic diagram of a preferred embodiment that the active isolated power supply with multiple outputs of the present invention is applied to APF system

FIG. 7 shows a partial schematic diagram of a driving circuit in the case that multiple outputs isolated power supply of the present invention is applied to APF

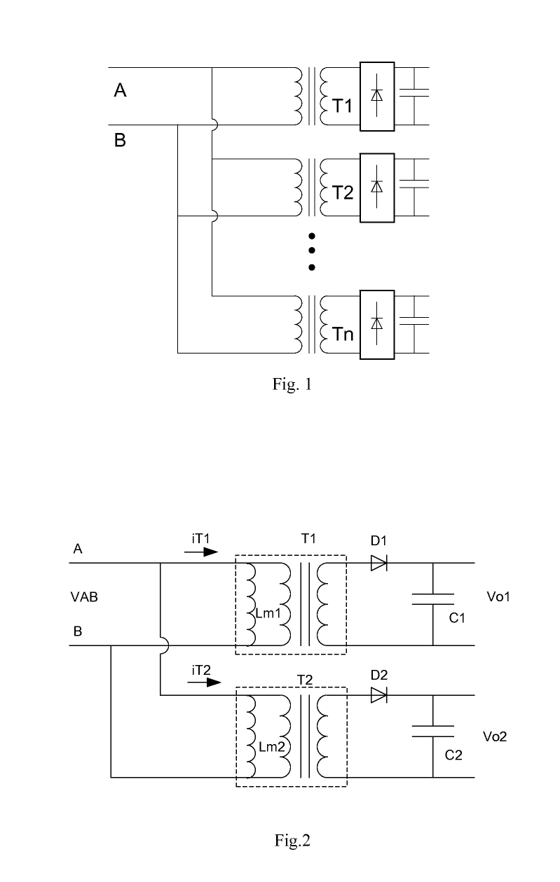

### DETAILED DESCRIPTION OF THE EMBODIMENTS

Some exemplary embodiments explaining the features and advantages of the present invention will be stated in detail in the following description. It is to be understood that different embodiments of the present invention have a variety of variations, which will fall within the scope of the present invention, and the description and figures are essentially used to explain the present invention, but not to limit the present invention.

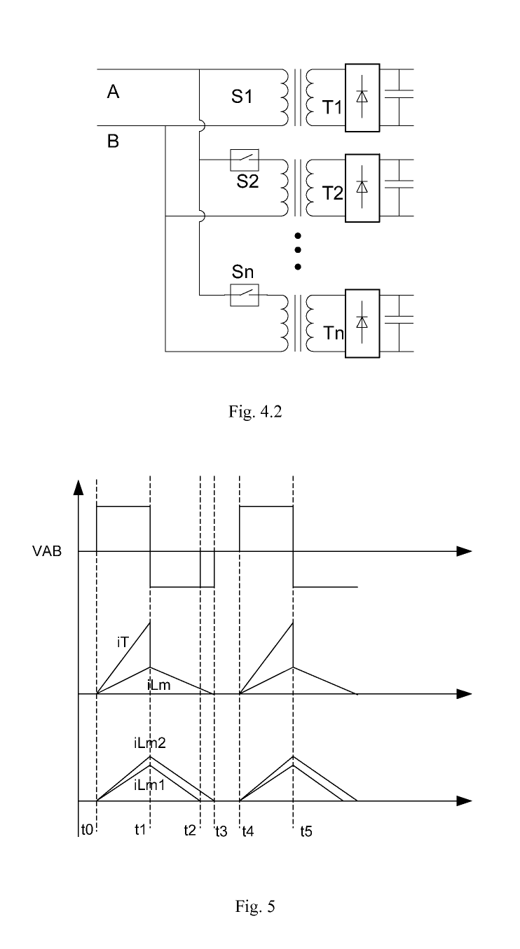

The features and beneficial effects mentioned above, as well as other features and effects of the active isolated power supply with multiple outputs of the present invention will be described in detail with preferred embodiments considered in conjunction with the attached FIGS. 4-7. The active isolated power supply with multiple outputs of the present invention could comprise multiple transformers T1˜Tn that bear different loads respectively.

FIG. 4.1 shows a circuit schematic diagram of the active isolated power supply with multiple outputs according to a preferred embodiment of the present invention. As shown in the figure, the active isolated power supply with multiple outputs of the embodiment is mainly composed of transformers T1˜Tn, whose primary sides are connected in parallel with each other and connected to the AC Source, wherein N is a positive integer number equals to or greater than 2. The AC voltage from the AC Source is generated via a push-pull circuit, a forward circuit, a flyback circuit, or a series isolated chopping circuit.

In order to restrict the current direction of the primary circuit of each transformers T1˜Tn, in a preferred embodiment of the present invention, multiple switching devices S1˜Sn are respectively connected in series with the primary circuit of the multiple transformers T1˜Tn, the number of which is equal to that of the transformers T1˜Tn. For example, switching device S1 or S2 are respectively connected in series with the primary sides of two transformers T1 and T2 when N is equal to 2.

In other embodiments of the present invention, each primary circuit of transformers T1˜Tn may comprise N−1 switching devices S1˜Sn−1, that is, N−1 switching devices S1˜Sn−1 are connected in series with the N−1 primary circuits of transformers T1˜Tn respectively, and even if one of the N switching devices S1˜Sn is absent, the objective of restricting current direction can still be achieved.

FIG. 4.2 shows a circuit schematic diagram of the active isolated power supply with multiple outputs according to another preferred embodiment of the present invention. As shown in the figure, N−1 switching devices S2˜Sn are respectively connected in series with the N−1 primary circuits of transformers T2˜Tn, while switching device S1 is absent from the primary side of transformer T1. Take the case of N equaling to 2 for example, if there is no switching device S1 in the primary side of transformer T1, and only switching device S2 is connected in series with the primary circuit of transformer T2, likewise, any magnetic current (whether iLm1 or iLm2) will not become negative, i.e. each magnetic current is forcibly returned to zero, because of the existence of switching device S2.

Switching devices S1˜Sn can be any one of the elements capable of breaking circuit as stated below: diode, Silicon-Controlled Rectifier (called SCR for short), the Triode AC switch (called TRIAC for short), Insulated Gate Bipolar Transistor (called IGBT for short), Metal Oxide Semiconductor Field Effect Transistor (called MOSFET for short), relay, Programmable Unijunction Transistor (called PUT for short), and so on.

Specifically, diode is suitable for simple circuit, requiring no controlling component; MOSFET element is appropriate for large current occasion because of its low turn-on voltage, but additional controlling part is also essential; as its high voltage endurance, IGBT is fit for high voltage application, which also need additional controlling device; as to relay, because it works mechanically, it is desirable that have it used in the cases of low frequency operation.

Moreover, In order to obtain multiple DC outputs isolated with each other, the secondary sides of transformer T1˜Tn are provided with rectifying circuits, which could be any type of rectifying circuits, such as an half-wave rectifying circuit, a full-wave rectifying circuit, a synchronous rectifying circuit, etc.

Next, operating principle of the present invention will be analysed in terms of isolated power supply with two outputs, but this will not constitute the limitation of the present invention.

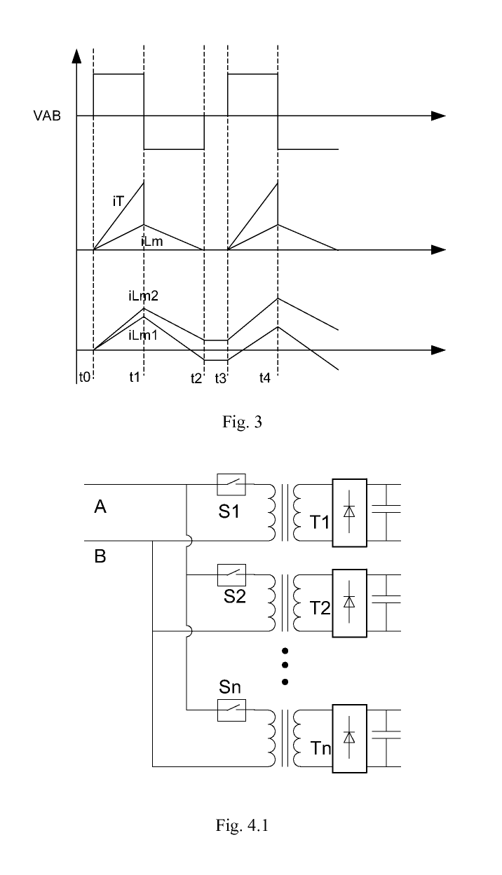

FIG. 5 shows the schematic diagram of the current circulation of an active isolated power supply with multiple outputs under the circumstance of having two different loads according to the embodiment of present invention. Similar to FIG. 3, in FIG. 5, V_{AB} is voltage of the input terminal AB of the primary sides of transformer T1 and T2, Lm1 and Lm2 are respectively equivalent magnetic inductance of the parallel transformer T1 and T2, Vo1 and Vo2 are DC voltage of the secondary sides of transformer T1 and T2 obtained by rectifying. The difference is that in the embodiment of the present invention switching devices S1 or S2 are respectively connected in series with the primary circuit of two transformers T1 and T2, thus, voltage V_{AB} of the AC Source is not directly loaded on the input terminals of transformer T1 and T2.

As shown in FIG. 5, V_{AB} represents the AC voltage waveform across the input terminal AB. Because of the difference of loads on the output terminals of transformer T1 and T2, there is difference between the output voltages, likewise, rising slopes of magnetic current iLm1 and iLm2 are different during the time period t0˜t1, and at the time t1˜t3, magnetic current iLm1 and iLm2 decrease with respective declining rate. Concretely, during the time period of t0˜t1, the voltage value of V_{AB} is positive, and the current waveforms of the primary sides of transformer T1 and T2 should be shown as iT in theory, i.e. positive triangular wave. However, the current waveforms of primary sides of the transformer T1 and T2 comprise magnetic current component iLm (iLm1 and iLm2) due to the existence of magnetic inductance, the difference of the current iT and current iLm1 is current induced to the secondary side of the first transformer T1, and the difference of current iT and current iLm2 is current induced to the secondary side of the second transformer T2.

At time t1, the voltage value of V_{AB} suddenly changes from positive to negative, causing the current induced to the secondary sides of the first and second transformer abruptly cut off. However, the magnetic current iLm (iLm1 and iLm2) is unable to change suddenly, the magnetic current iLm (iLm1 or iLm2) decrease slowly till to be zero in the time period of t1˜t3, i.e. the magnetic current iLm1 is zero at time t2, the magnetic current iLm2 is zero at time t3, and meanwhile the voltage value of V_{AB} return to zero. That is to say, with the active isolated power supply with multiple outputs of the present invention, because of the existence of switching devices S1 or S2, the magnetic current iLm (iLm1 or iLm2) of transformer T1 or T2 is all forcedly returned to zero, and any current iLm (iLm1 and iLm2) will not become negative at any time. Therefore, current circulation will impossibly occur between the primary sides of transformers T1 and T2, their magnetic cores will accomplish magnetic reset, and won't become saturate.

In the same way, if only one of the switching devices S1 or S2 is connected in series with the primary sides of the two transformers T1 and T2, then the principle and effect is the same as the case that switching devices S1 or S2 are respectively connected in series with the primary sides of the two transformers T1 and T2, so will not go into the details here.

Hence, in the embodiment of the present invention as mentioned above, the primary sides of transformers T1˜Tn are not directly connected in parallel, but respectively connected in series with N switching devices S1˜Sn or N−1 switching devices S1˜Sn−1, which can restrict the flow direction of the current. Thus, the current direction of the primary side of any one of transformers T1˜Tn is fixed, thereby, the current circulation won't exist between the primary circuits, and each transformer T1˜Tn can achieve magnetic reset during one operation period, such that margin needn't to be considered in the design of transformers T1˜Tn.

In the following, a preferred embodiment will be described that the present invention is applied to feed power to the driving circuit of APF system.

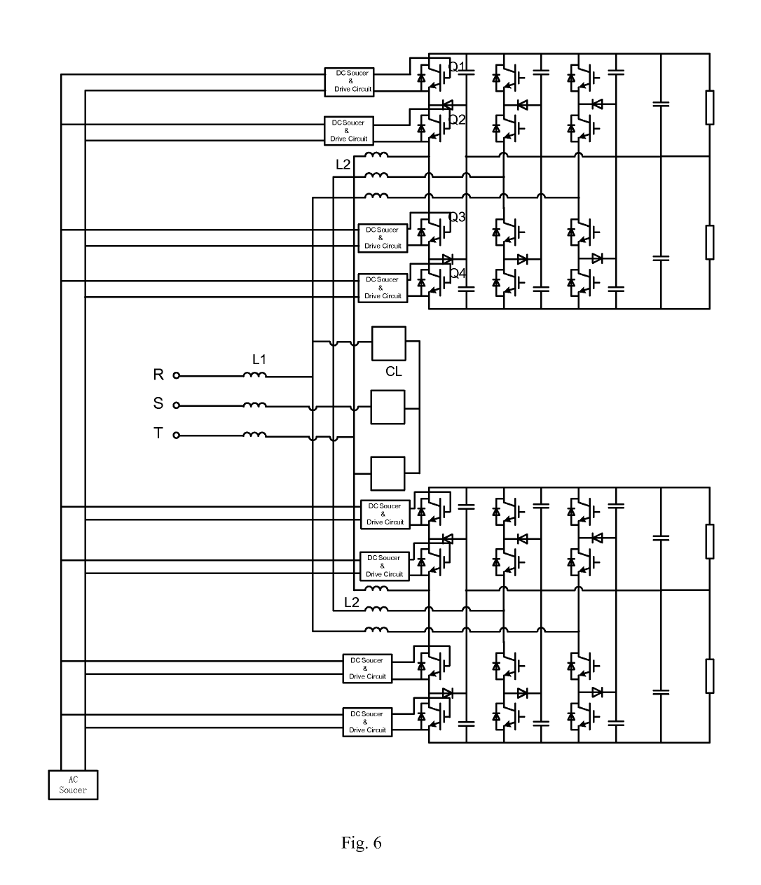

FIG. 6 shows a circuit schematic diagram of the preferred embodiment that the active isolated power supply with multiple outputs of the present invention is applied to an APF system. As shown in the figure, the Active Power Filter system comprises main power circuit of APF which is composed of two sets of three-level inverters, and adopts LCL (inductor-capacitor-inductor) filtering circuit to filter harmonic component. Three-level inverter is usually used in Uninterruptible Power System (called UPS for short) as well as frequency converter and so on.

Normally, the main power circuit may include M switching devices K1˜Km and matched driving circuit thereof, wherein M could be a positive integer number equals to or greater than 2. Three-level inverter circuit requires driving circuit to drive each applied switching device (e.g. IGBT, MOSFET or other switching device) in isolation. In the embodiment of the present invention, M is equal to 24, that is to say, the two sets of three-level inverters have 24 switching devices IGBTs in all. Therefore, 24 sets of voltage outputs of the active isolated power supply of the present invention are required to feed power to the driving circuits of the 24 switching device IGBTs respectively.

It should be noted that in FIG. 6 only 8 sets of driving circuits of the switching device IGBT and matched active isolated power supply output structure thereof on the left side are shown, the other remaining 16 sets which are the same as the 8 sets mentioned before are not described in detail any more. In addition, for the sake of convenience in practical application, the power circuit in FIG. 6 can be configured into two sets of active isolated power supplies with multiple outputs having the same number of outputs (each includes 12 outputs) to supply power to the 24 driving circuits of switching device IGBTs in the main power circuit of the APF system respectively.

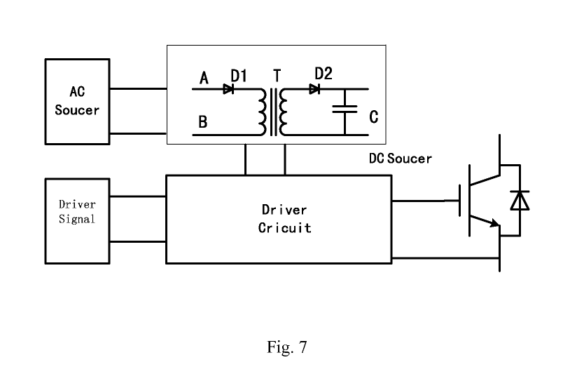

FIG. 7 shows the partial schematic diagram of a driving circuit in the case that multi-output isolated power supply of the present invention is applied to the APF. While in the figure only one input terminal AB of the active isolated power supply with multiple outputs is shown to be connected to the output terminal of AC power supply on power grid side, in practice, the 24 input terminals AB of the active isolated power supply with multiple outputs are connected together with each other, to obtain power from the AC power supply on the power grid side unitedly. Furthermore, the active isolated power supply with multiple outputs comprises 24 isolated transformers T1˜T24, whose primary circuits are connected in series with switching devices S1˜S24 respectively. To avoid the occurrence of the current circulation between the primary circuits of isolated transformers of the power supply, in another preferred embodiment of the present invention, among the primary circuits of isolated transformers T1˜T24, 23 primary circuits are connected in series with 23 switching devices respectively, the remaining one primary circuit is not connected with switching device, but the principle and effect are the same as the case that switching devices S1˜S24 are respectively connected in series with the primary circuits of isolated transformers T1˜T24.

As shown in FIG. 7, an output terminal of the active isolated power supply with multiple outputs is connected to a driving circuit, which is fed power from the active isolated power supply and receives control signal to drive switching device IGBT to perform on-off operation. In the embodiment of the present invention, the switching devices S1˜S24 in the active isolated power supply with multiple outputs are all diodes, as D1 shown in the figure. This 24 switching devices S1˜S24 have all the primary circuits of isolated transformers T1˜T24 not directly connected in parallel with each other, preventing reverse flow of current in certain primary circuits. On the secondary side of isolated transformers T1˜T24, therein rectifying circuits could be any rectifying circuits, such as an half-wave rectification, a full-wave rectification, a synchronous rectification, etc. In the embodiment of the present invention, the rectifying circuit is an half-cycle uncontrolled rectifying circuit, which comprises rectifier composed of uncontrolled rectifying diode D2 connected in series with the secondary side and capacitor C connected in parallel between the output terminals of the active isolated power supply with multiple outputs , to perform uncontrolled rectifying.

It is turned out that the bulk of driving power supply could be decreased greatly, once the embodiments of the active isolated power supply with multiple outputs of the present invention is applied to feed power to driving circuit in the APF system. The whole size of the apparatus is reduced considerably, compared to the occasion using conventional active isolated power supply with multiple outputs.

What have been stated above are only preferred embodiments of the present invention, but the patent scope of the present invention is not limited to this. Any equivalent structure variation based on the content of the description and figures of the present invention should fall within the scope of the present invention.

1. An active isolated power supply with multiple outputs, comprising:
N transformers T1˜Tn connected to output terminal of AC Source, whose primary circuits are connected in parallel with each other, wherein N is a positive integral number equals to or greater than 2; and
N switching devices (S1˜Sn) or N−1 switching devices (S1˜Sn−1) connected in series with different primary circuits of the transformers (T1˜Tn) respectively to restrict the current direction of the primary circuits of the transformers (T1˜Tn); wherein, N output power supplies isolated with each other are generated on the secondary sides of the transformers (T1˜Tn).

2. The active isolated power supply with multiple outputs according to claim 1, wherein further comprising rectifying circuits at the secondary sides of the transformers (T1˜Tn), the rectifying circuits rectify the N output power supplies to obtain N DC power supplies isolated with each other.

3. The active isolated power supply with multiple outputs according to claim 1, wherein the AC Source is generated via a push-pull circuit, a forward circuit, a flyback circuit or a series isolated chopping circuit.

4. The active isolated power supply with multiple outputs according to claim 2, wherein the rectifying circuits of the transformers (T1˜Tn) are an half-wave rectifying circuit, a full-wave rectifying circuit, or a synchronous rectifying circuit.

5. The active isolated power supply with multiple outputs according to claim 1, wherein the switching devices (S1˜Sn or S1˜Sn−1) on the primary sides of the transformers (T1˜Tn) are diodes.

6. The active isolated power supply with multiple outputs according to claim 1, wherein the switching devices (S1˜Sn or S1˜Sn−1) on the primary sides of the transformers (T1˜Tn) are MOSFETs, which are controlled by controlling unit to be on or off.

7. The active isolated power supply with multiple outputs according to claim 1, wherein the switching devices (S1˜Sn or S1˜Sn−1) on the primary sides of the transformers (T1˜Tn) are IGBTs, which are controlled by controlling unit to be on or off.

8. The active isolated power supply with multiple outputs according to claim 1, wherein the switching devices (S1˜Sn or S1˜Sn−1) on the primary sides of the transformers (T1˜Tn) are relays.

9. The active isolated power supply with multiple outputs according to claim 2, wherein the switching devices (S1˜Sn or S1˜Sn−1) on the primary sides of the transformers (T1˜Tn) are diodes.

10. The active isolated power supply with multiple outputs according to claim 2, wherein the switching devices (S1˜Sn or S1˜Sn−1) on the primary sides of the transformers (T1˜Tn) are MOSFETs, which are controlled by controlling unit to be on or off.

11. The active isolated power supply with multiple outputs according to claim 2, wherein the switching devices (S1˜Sn or S1˜Sn−1) on the primary sides of the transformers (T1˜Tn) are IGBTs, which are controlled by controlling unit to be on or off.

12. The active isolated power supply with multiple outputs according to claim 2, wherein the switching devices (S1˜Sn or S1˜Sn−1) on the primary sides of the transformers (T1˜Tn) are relays.

13. The active isolated power supply with multiple outputs according to claim 3, wherein the switching devices (S1˜Sn or S1˜Sn−1) on the primary sides of the transformers (T1˜Tn) are diodes.

14. The active isolated power supply with multiple outputs according to claim 3, wherein the switching devices (S1˜Sn or S1˜Sn−1) on the primary sides of the transformers (T1˜Tn) are MOSFETs, which are controlled by controlling unit to be on or off.

15. The active isolated power supply with multiple outputs according to claim 3, wherein the switching devices (S1˜Sn or S1˜Sn−1) on the primary sides of the transformers (T1˜Tn) are IGBTs, which are controlled by controlling unit to be on or off.

16. The active isolated power supply with multiple outputs according to claim 3, wherein the switching devices (S1˜Sn or S1˜Sn−1) on the primary sides of the transformers (T1˜Tn) are relays.

17. An active power filter comprising:
main power circuit, which comprises M switching devices (K1˜Km) and matched driving circuits thereof, wherein M is a positive integral number equals to or greater than 2; and
active isolated power supply with multiple outputs as stated in claim 1, the input terminals of the active isolated power supply with multiple outputs receive AC power from the AC source to feed power to the driving circuits.

18. The active power filter according to claim 17, wherein the switching devices connected in series with the primary sides of transformers of the active isolated power supply with multiple outputs are diodes, rectifying circuits on the secondary sides of the transformers are half-cycle uncontrolled rectifying circuits.

19. The active power filter according to claim 17, wherein the switching devices (K1˜Km) are IGBTs or MOSFETs.

20. The active power filter according to claim 19, wherein the switching devices connected in series with the primary sides of transformers of the active isolated power supply with multiple outputs are diodes, rectifying circuits on the secondary sides of the transformers are half-cycle uncontrolled rectifying circuits.
